(19) United States
(12) Patent Application Publication
(10) Pub. No.: US 2009/0072207 A1
(43) Pub. Date: Mar. 19, 2009

(54) FLAME RETARDANT RESIN COMPOSITION FOR PRINTED CIRCUIT BOARD, PRINTED CIRCUIT BOARD USING THE SAME AND MANUFACTURING METHOD THEREOF

(75) Inventors: Jae-Choon CHO, Suwon-si (KR); Jun-Rok Oh, Seoul (KR); Keun-Yong Lee, Yongin-si (KR); Sang-Moon Lee, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/937,038

(22) Filed: Nov. 8, 2007

(30) Foreign Application Priority Data
Sep. 13, 2007 (KR) 10-2007-0092874

(51) Int. Cl. C09K 21/00; B29C 65/00

(52) U.S. Cl. 252/609; 156/273.3

(57) ABSTRACT

The present invention relates to a flame retardant resin composition for a printed circuit board and a printed circuit board using the same, in more detail, to a flame retardant resin composition which includes a complex epoxy resin, photo acid generator, a curing agent, a curing accelerator, and an inorganic filler, so that UV curable and property-maintainable insulating material can be manufactured, and to a printed circuit board using the same.

The flame retardant resin composition according to the present invention contains a photo acid generator instead of an acrylate reactive diluent which is included UV curable insulating material so that fine patterned printed circuit board can be manufactured through UV curing and post thermal curing.

### CROSS-REFERENCE TO RELATED APPLICATIONS

This application claims the benefit of Korean Patent Application No. 10-2007-0092874 filed on Sep. 13, 2007 with the Korean Intellectual Property Office, the contents of which are incorporated here by reference in their entirety.

### BACKGROUND

1. Technical Field

The present invention relates to a flame retardant resin composition for a printed circuit board, a printed circuit board using the same and a manufacturing method thereof, more particularly, to a flame retardant resin composition for a printed circuit board enabling manufacturing UV curable as well as property-maintainable dielectric materials.

2. Description of the Related Art

Recently, in response to the trend for electronic devices such as semiconductor with higher speed, greater capacity, and mobilization, the demand for thinner substrates and higher integrated circuits for FCBGA (Flip Chip Ball Grid Array), which interconnects semiconductor and main board, has been increased.

A method for forming a wiring pattern by using a conventional photo lithography type has many problems including a limit in forming a micro-wiring by the use of a photoresist, and complications in processing. Recently, an imprinting lithographic method for forming a micro wiring pattern to the nano size has been proposed. This imprinting lithographic method forms a micro-pattern with forming a pattern by stamping on a conventional insulating material with a fixed curing degree in the semi-hardened state and plating a conductive metal inside the pattern. But in case of the imprinting lithographic method, there are some problems that a selection of a curing degree is narrow, so that a restriction is brought to the processing condition, it is difficult to obtain exact curing conditions, so that a transfer is not made, or a stamp has the problem of releasing property, so that the defect rate of a substrate is raised. In addition, to form a circuit pattern using the above process, an imprintable material is also required as an insulating material.

Both nickel-based stampers and polymer-based stampers are widely used in the imprinting lithography. The nickel-based stamper has an excellent durability and no restriction for reaction temperature. However, it is costly and difficult to achieve a conformal contact and UV curable materials cannot be used.

In case of polymer-based stamper, it has poor durability and a limitation regarding reaction temperature. However, it is economical and easily allows a conformal contact and UV curable materials can be used. However general UV curable insulating material has excess amount of acrylate monomers as a reaction diluent which deteriorates thermal and mechanical properties of the insulating material.

Therefore, developing new insulating materials having a UV curable material but not deteriorating thermal and mechanical properties are demanded.

### SUMMARY

The present invention solves the problems associated with the conventional technologies, in detail, provides a flame retardant resin composition not only which shows an excellent thermal stability, an excellent mechanical strength and a suitability for the imprinting lithography method but also which may improve the reliability of a substrate by reducing the thermal expansion, and a printed circuit board using the same.

Additional aspects and advantages of the present general inventive concept will be set forth in part in the description which follows and, in part, will be obvious from the description, or may be learned by practice of the general inventive concept.

One aspect of the present invention may provide a flame retardant resin composition for a printed circuit board, the flame retardant resin composition including:

(a) a complex epoxy resin including 1 to 40 parts by weight of a bisphenol A type epoxy resin with an average epoxy resin equivalent of 100 to 700, 1 to 60 parts by weight of a cresol novolac epoxy resin with an average epoxy resin equivalent of 100 to 600, 1 to 20 parts by weight of a rubber-modified epoxy resin with an average epoxy resin equivalent of 100 to 500, and 1 to 30 parts by weight of a phosphorus type epoxy resin with an average epoxy resin equivalent of 400 to 800; (b) a photo acid generator mixed 0.1 to 10 parts by weight on the basis of 100 parts by weight of the complex epoxy resin; (c) a curing agent mixed an equivalent ratio of 0.1 to 1.3 with respect to the total epoxy group equivalent of the complex epoxy resin; (d) a curing accelerator mixed 0.1 to 1 parts by weight on the basis of 100 parts by weight of the complex epoxy resin; and (e) an inorganic filler mixed 10 to 50 parts by weight on the basis of 100 parts by weight of the complex epoxy resin.

According to one embodiment of the present invention, the photo acid generator is a cationic photo initiator.

According to another embodiment of the present invention, the cationic photo initiator is at least one selected from a group consisting of aryl diazonium salt, diaryliodonium salt, triaryl sulphonium salt, triaryl selenonium salt, dialkyl phenacyl sulphonium salt, triaryl sulphoxonium salt, aryloxydiaryl sulphoxonium salt and dialkyl phenacyl sulphoxonium salt having at least one anion selected from the group consisting of BF₄⁻, PF₆⁻, AsF₆⁻, and SbF₆⁻.

According to another embodiment of the present invention, the curing agent is at least one selected form a group consisting of phenol novolac, bisphenol novolac and a mixture thereof.

According to another embodiment of the present invention, the curing accelerator may be an imidazole compound, such as at least one selected from the group consisting of 2-ethyl-4-methylimidazole, 1-(2-cyanoethyl)-2-alkylimidazole, 2-phenyl imidazole and a mixture thereof.

According to another embodiment of the present invention, the inorganic filler may be at least one inorganic material selected from the group consisting of barium titanium oxide, barium strontium titanate, titanium oxide, lead zirconium titanate, lead lanthanum zirconate titanate, lead magnesium niobate-lead tiatanate, silver, nickel, nickel-coated polymer sphere, gold-coated polymer sphere, tin solder, graphite, tantalum nitride, metal silicon nitride, carbon black, silica, clay and aluminum borate. Also, the inorganic filler may be surface-treated with a silane coupling agent, and may include spherical fillers of which the sizes are respectively different.

Another aspect of the present invention may provide a printed circuit board of which an insulating layer is formed by using the flame retardant resin composition.

Another aspect of the present invention may provide a method for manufacturing a printed circuit board including:

laminating an insulating layer formed from the above flame retardant resin composition to a substrate;

imprinting the substrate using an extruded patterned stamper and UV curing; and

releasing the stamper and thermal curing

According to another embodiment of the present invention, the stamper has polymer material.

### DETAILED DESCRIPTION

Hereinafter, a flame retardant resin composition for a printed circuit board, and a printed circuit board which employs the flame retardant resin composition, will be explained in more detail.

The imprinting lithographic process is a method of forming a micro-pattern by transcribing a wiring pattern on a substrate softened by pressing a mold serving as a stamper with a proper pressure at a fixed temperature, and plating a conductive metal inside the pattern along the transcribed wiring pattern.

The present invention relates to resin composition for manufacturing an insulating material that can be applied to UV curing by adding an optimum amount of a photo acid generator to the thermally curable insulating material and at the same time does not deteriorate existing properties. In imprinting process using the composition, a circuit board having micro-wires can be manufactured by UV curing using a polymer stamper, post curing after releasing the stamper, and plating the formed trench.

A flame retardant resin composition for a printed circuit board of the present invention may include (a) a complex epoxy resin comprising 1 to 40 parts by weight of a bisphenol A type epoxy resin with an average epoxy resin equivalent of 100 to 700, 1 to 60 parts by weight of a cresol novolac epoxy resin with an average epoxy resin equivalent of 100 to 600, 1 to 20 parts by weight of a rubber-modified epoxy resin with an average epoxy resin equivalent of 100 to 500, and 1 to 30 parts by weight of a phosphorus type epoxy resin with an average epoxy resin equivalent of 400 to 800; (b) photo acid generator mixed 0.1 to 10 parts by weight on the basis of 100 parts by weight of the complex epoxy resin; (c) a curing agent mixed an equivalent ratio of 0.1 to 1.3 with respect to the total epoxy group equivalent of the complex epoxy resin; (d) a curing accelerator mixed 0.1 to 1 parts by weight on the basis of 100 parts by weight of the complex epoxy resin; and (e) an inorganic filler mixed 10 to 50 parts by weight on the basis of 100 parts by weight of the complex epoxy resin.

The complex epoxy resin according to the present invention is an epoxy resin which does not include a halogen but a bisphenol A type epoxy resin, a cresol novolac epoxy resin, a rubber-modified epoxy resin and a phosphorus type epoxy resin.

Here, the bisphenol A type epoxy resin may have an average epoxy resin equivalent of 100 to 700. It is not preferable if the average epoxy resin equivalent is less than 100, because it is difficult to obtain desired properties. Also it is not preferable if the average epoxy resin equivalent is more than 700 because it is difficult to dissolve in a solvent and to control due to a high melting point. Also, a content of the bisphenol A type epoxy resin may be 1 to 40 parts by weight in the complex epoxy resin. It is not preferable if the content of bisphenol A type epoxy resin is less than 1 parts by weight because the adhesive force with the wiring material is deteriorated. Also it is not preferable if the content of bisphenol A type epoxy resin is more than 40 parts by weight because the thermal property and the electrical property decrease. The resin may be used by dissolving in a mixed solvent of 2-methoxyethanol, methyl ethyl ketone (MEK), dimethyl formamide (DMF) and methyl cellosolve (MCS).

The cresol novolac epoxy resin can be used as an epoxy resin of the novolac type. This is because that a cured material with high heat resistance can be obtained and that the thermal stability of a formed substrate can be improved. An average epoxy resin equivalent of the cresol novolac epoxy resin may be 100 to 600 and a content of the cresol novolac epoxy resin may be 1 to 60 parts by weight in the complex epoxy resin. It is not preferable if the average epoxy resin equivalent is less than 100 because it is difficult to obtain desired properties. Also it is not preferable if the average epoxy resin equivalent is more than 600 because it is difficult to dissolve in a solvent and to control due to a high melting point. Also, it is not preferable if the content of the cresol novolac epoxy resin is less than 1 part by weight because it is difficult to obtain desired properties. Also it is not preferable if the content of the cresol novolac epoxy resin is more than 60 parts by weights because the electrical and the mechanical property are lowered. The cresol novolac epoxy resin may be used by dissolving in a mixed solvent of 2-methoxyethanol, methyl ethyl ketone (MEK), dimethyl formamide (DMF) and methyl cellosolve (MCS).

The rubber-modified epoxy resin may be epoxy resin modified by ATBN, CTBN, etc. For example, the rubber-modified epoxy resin may be obtained by mixing DGEBA (diglycidyl ether of bisphenol A) and ATBN (amine terminated butadiene acrylonitrile copolymer), and its average epoxy resin equivalent may be 100 to 500. It is not preferable if the average epoxy resin equivalent is less than 100 because it is difficult to obtain desired properties. Also it is not preferable if the average epoxy resin equivalent is more than 500 because it is difficult to dissolve in a solvent and to control due to a high melting point. The content of the rubber-modified epoxy resin may be 1 to 20 parts per weight in the complex epoxy resin. It is not preferable if a content of the rubber-modified epoxy resin is less than 1 part by weight because desired properties cannot be obtained. Also it is not preferable if the content of the rubber-modified epoxy resin is more than 20 parts by weight because an insulating material may be easily broken which further causes cracks. The resin may be used by dissolving in a mixed solvent of 2-methoxyethanol, methyl ethyl ketone (MEK), dimethyl formamide (DMF) and methyl cellosolve (MCS).

The phosphorus type epoxy resin may be a epoxy resin containing phosphorus and it shows excellent flame retardant and self-extinguishing property. The phosphorus type epoxy resin may be added in order to give a flame retardant property of a printed circuit board. And an enviroment-friendly flame retardant substrate can be obtained because halogen is not included in the flame retardant substrate. An average epoxy resin equivalent of the phosphorus type epoxy resin may be 400 to 800. It is not preferable if the average epoxy resin equivalent is less than 400 because desired properties are not obtained. Also it is not preferable if the average epoxy resin equivalent is less than 800 because it is difficult to dissolve in a solvent and to control due to a high melting point. The content of the phosphorus type epoxy resin may be 1 to 30 parts by weight in the complex epoxy resin. It is not preferable if the content of the phosphorus type epoxy resin is less than 1 part by weight because it is difficult to obtain a flame retardant property. Also it is not preferable if the content of the phosphorus type epoxy resin is more than 30 parts by weight because electrical and mechanical properties decrease. The resin may be used by dissolving in a mixed solvent of 2-methoxyethanol, methyl ethyl ketone (MEK), dimethyl formamide (DMF) and methyl cellosolve (MCS).

In the present invention, the photo acid generator may be any compound that can generate acid by light, for example, compounds disclosed in U.S. Pat. No. 5,212,043 (1993 May 18), WO 97/33198 (1997 Sep. 12,), WO 96/37526 (1996 Nov. 28), EP 0 794 458 (1997 Sep. 10), EP 0 789 278 (1997 Aug. 13,), U.S. Pat. No. 5,750,680 (1998 May 12,), GB 2,340,830 A (2000 Mar. 1,), U.S. Pat. No. 6,051,678 (2000 Apr. 18,), GB 2,345,286 A (2000 Jul. 5,), U.S. Pat. No. 6,132,926 (2000 Oct. 17,), U.S. Pat. No. 6,143,463 (2000 Nov. 7,), U.S. Pat. No. 6,150,069 (2000 Nov. 21,), U.S. Pat. No. 6,180,316 B1 (2001 Jan. 30,), U.S. Pat. No. 6,225,020 B1 (2001 May 1,), U.S. Pat. No. 6,235,448 B1 (2001 May 22,) and U.S. Pat. No. 6,235,447 B1 (2001 May 22,) may be included.

The compound, that can generate acid by light, may be onium salt, latent sulphonic acid, halomethyl-s-triazine, or metallocene or chlorinated acetophenone or benzoin phenyl ether.

Examples of onium salt photo initiators include aryl diazonium, diaryliodonium; triaryl sulphonium, triaryl selenonium, dialkyl phenacyl sulphonium, triaryl sulphoxonium, aryloxydiaryl sulphoxonium, dialkyl phenacyl sulphoxonium salts, and their salts with BF₄⁻, PF₆⁻, AsF₆⁻, or SbF₆⁻, more preferably, the diaryliodonium and triaryl sulphonium salts.

The latent sulphonic acid is a compound which produces a sulphonic acid during the light irradiation. Examples of the latent sulphonic acids include α-sulphonyloxy ketones, e.g. benzoin tosylate, 4′-methylthio-2-(p-tosyloxy) propiophenone, α-toluene sulphonyloxy propiophenone; α-hydroxymethylbenzoin sulphonates, e.g. the methane sulphonate and p-toluene sulphonate of α-hydroxymethyl benzoin; nitrobenzyl esters of sulphonic acids, e.g. 4-nitrobenzyl tosylate, 2,4-and 2,6-dinitrobenzyl tosylate, p-nitrobenzyl-9,10-diethoxyanthracene-2-sulphonatel aryl diazidonaphthaquinone-4-sulphnates; 4′-Nitrobenzyl 2,4,6-trilisopropylbenzenesulphone, α-sulphonyl acetophenones, e.g. α-toluene sulphonyl acetophenone and 2-methyl-2-(4-methylphenyl sulphonyl)-1-phenylpropane; methane sulphonate esters of 2-hydroxy- and 2,4-dihydroxy benzophenone; and 1,2,3,4-tetrahydro-1-naphthylideneimino-p-toluene sulphonate.

An example of the halo methyl-s-triazines includes 2-aryl-4,6-bis chloromethyl-s-triazines and examples of the chlorinated acetophenones include 4-tert-butyl-α,α,α,-trichloroacetophenone and 4-phenoxy-α,α-bis-dichloroacetophenone.

An example of the metallocene includes (cyclopentadi-1-enyl)[(1,2,3,4,5,6-n-(-(1-methylethyl)benzene)-iron(1+)-hexafluoro phosphate (1−) and the like.

In addition, examples of the cationic photo polymerizing initiator include diazonium, aryldiazonium, iodonium, diaryliodonium, sulphonium, triaryl sulphonium, dialkylphenacylsulphonium, triarylsulphoxonium, aryloxydiarylsulphoxonium, dialkylphenacyl sulphoxonium, triarylselenonium, ferrocenium, metal chelate, arylsilanolinealumium chelate, etc.

Dimethyl-4-hydroxyphenylsulphonium hexafluoroarsenate, bis(dodecylphenyl)iodonium hexafluoroantimonate, phenyldiazonium hexafluorophosphate, diphenyliodonium hexafluorophosphate, 4-methoxyarsenate, triphenylsulphonium hexafluoroarsenate, (cumen)cyclopentadienyliron(II) hexafluorophosphate, bis[4-(diphenylsulphonio)-phenyl]sulfide bis-hexafluorophosphate, bis[4-(di(4-(2-hydroxyethyl)phenyl)sulphonio-phenyl]sulfide bis-hexafluoro phosphate, etc are also included in the examples of the cationic photo polymerizing initiator.

The cationic initiator is sensitive for humidity and contamination and requires post-heat curing. It reacts fast and has little volume contraction. Also it is not much influenced by oxygen and requires little energy.

In the present invention, the photo acid generator may be added by 0.1 to 10 parts by weight on the basis of 100 parts by weight of the complex epoxy resin. If the content of the photo acid generator is less than 0.1 parts by weight, cations are not generated smoothly, so that the curing cannot be conducted amicably. Also, if the content of the photo acid generator is more than 10 parts by weight, it deteriorates properties.

The curing agent according to the present invention improves a thermal stability of an insulating material. In the present invention, it can be at least one selected from a group consisting of phenol novolac, bisphenol novolac and mixture thereof. By using the phenol novolac curing agent including a nitrogen-based compound, a resin composition having an excellent flame retardancy and a low thermal expansion can be obtained. A softening temperature of the curing agent may be 100 to 150° C., a content of nitrogen may be 10 to 30 wt. %, and a hydroxyl group equivalent may be 100 to 200.

According to another embodiment, an equivalent ratio of the curing agent may be 0.1 to 1.3 with respect to the total epoxy group equivalent of the complex epoxy resin. If the curing agent is mixed within the range of the equivalent ratio, a curing degree of a cured insulating layer, in other words, of a substrate can be controlled to a desired extent and the thermal expansion of a substrate can be reduced to the utmost. It is not desirable if the equivalent ratio is less than 0.1 because a flame retardancy of a composition decreases. Also it is not desirable if the ratio is more than 1.3 because an adhesive property and magnetic field stability decrease. More desirably, the curing agent is mixed with an equivalent ratio of 0.7. Also, the total epoxy group equivalent of complex epoxy resin may be obtained from epoxy group equivalent of each epoxy resin and a sum thereof.

The curing accelerator according to the present invention may be an imidazole type curing accelerator. Also the curing accelerator according to the present invention may be one selected from the group consisting of 2-ethyl-4methylimidazole, 1-(2-cyanoethyl)-2-alkylimidazole, 2-phenyl imidazole and a mixture thereof, but it is not limited to them. Here, the curing accelerator may be added by 0.1 to 1 parts by weight on the basis of 100 parts by weight of the complex epoxy resin. If the content of the curing accelerator is less than 0.1 parts by weight, the speed of curing may significantly decrease, the curing may not be completed and a problem in releasing may be occurred in the imprinting process. Also, if the content of the curing accelerator is more than 1 part by weight, the fast curing is occurred, so that a pattern may not be transferred in the imprinting process.

Additionally a content of the phosphorous flame retardant epoxy resin, of which the price is relatively high, can be lowered by adding a flame retardant adjuvant. The compound such as Al₂O₃ which additionally has a phosphorous can be used as the flame-retardant adjuvant.

The inorganic filler according to the present invention can be added in order to reinforce a mechanical strength of a cured material which is usually insufficient in a cured material including only epoxy resins, and may be any electric insulating material which is generally used. Examples of the inorganic filler may be at least one inorganic material selected from the group consisting of barium titanium oxide, barium strontium titanate, titanium oxide, lead zirconium titanate, lead lanthanum zirconate titanate, lead magnesium niobate-lead tiatanate, silver, nickel, nickel-coated polymer sphere, gold-coated polymer sphere, tin solder, graphite, tantalum nitride, metal silicon nitride, carbon black, silica, clay and aluminum borate, but it is not limited to such examples set forth above.

Here, the inorganic filler may be added by 10 to 50 parts by weight on the basis of 100 parts by weight of the complex epoxy resin. It is not preferable if the content of the inorganic filler is less than 10 parts by weight because it is difficult to obtain a desired mechanical property. Also it is not preferable if the content of the inorganic filler is more than 50 parts by weight because the phase separation may occur.

The surface of the inorganic filler may be treated with a silane coupling agent in order to promote affinity to the epoxy resin by a chemical bonding. The silane coupling agent may be amino type, epoxy type, acryl type, vinyl type, or the like, but not limited to them. Moreover, the inorganic filler having a spherical shape and different sizes, may be used to increase flowability inside the resin composition and thermal and mechanical properties by raising packing density after curing. The size of the inorganic filler may be 1˜150 μm, desirably, 5˜75 μm.

The flame retardant resin composition according to the present invention may be suitable for a variety of substrates with insulating layers including BGAs, for example, a flexible printed circuit board (FPCB), a rigid PCB, a rigid-flexible PCB, a built-up substrate, a FCBGA (Flip chip ball grid array) and a PBGA (plastic ball grid array).

The printed circuit board using the flame retardant resin composition may be manufactured. The method for manufacturing a fine patterned printed circuit board includes but is not limited to the following process; laminating an insulating layer on a substrate and preparing an extruded patterned, performing an imprinting process, releasing the stamper after UV curing, post thermal curing and forming a plating layer on the formed engraved pattern.

Not limited this, the stamper may be a nickel stamper or a polymer stamper, especially, in the present invention, a transparent polymer stamper that can be applicable to the UV curable material is preferable. A nickel stamper has an excellent durability, however, it is costly and difficult to achieve a conformal contact. The polymer stamper has poor durability compared with nickel stamper, however, it is economical and UV curing can be applied because of its transparency and its flexibility can easily achieve a conformal contact. Therefore, it is advantageous for uniform imprinting.

Embodiments relating a flame retardant resin composition were set forth above, hereinafter, explanations will be given in greater detail with reference to specific examples, and the protection scope of the present invention is not restricted to the following example.

### EXAMPLE 1

A 85 weight % bisphenol A type epoxy resin (Kookdo chemistry, YD-011, 475 g/eq) of 14.99 g (solvent: 2-methoxyethanol), a 85 weight % cresol novolac epoxy resin (Kookdo chemistry, YDCN-500-01P, 206 g/eq) of 73.33 g (solvent: 2-methoxyethanol), a rubber-modified epoxy resin (Kookdo chemistry, Polydis 3615, 300 g/eq) of 10 g, a 85 weight % phosphorous type flame retardant epoxy resin (Kookdo chemistry, KDP-550MC65, 590 g/eq) of 37.48 g (solvent: 2-methoxyethanol), and a 66.7 weight % amino triazine type novolac curing agent (GUN EI Chemical Industry co., ltd, PS-6313, 148 g/eq) of 56.50 g (solvent: 2-methoxyethanol) were mixed with triarylsulphonium salt having PF6- and SbF8- as a photo acid generator of 5 g, and the mixture was agitated with a rate of 300 rpm, at 90° C., for 1 hour. Subsequently, after adding a 70.93 g of spherical silica having a size distribution of 0.6 to 1.2 μm, the mixture was agitated with a rate of 400 rpm for 3 hours. After lowering the temperature of the mixture to room temperature, a 2-ethyl-4-methyl imidazole of 0.5 g was added and agitated for 30 minutes to provide an insulating material composition.

### COMPARATIVE EXAMPLE

A 85 weight % bisphenol A type epoxy resin (Kookdo chemistry, YD-011, 475 g/eq) of 14.99 g (solvent: 2-methoxyethanol), a 85 weight % cresol novolac epoxy resin (Kookdo chemistry, YDCN-500-01P, 206 g/eq) of 73.33 g (solvent: 2-methoxyethanol), a rubber-modified epoxy resin (Kookdo chemistry, Polydis 3615, 300 g/eq) of 10 g, a 85 weight % phosphorous type flame retardant epoxy resin (Kookdo chemistry, KDP-550MC65, 590 g/eq) of 37.48 g (solvent: 2-methoxyethanol), and a 66.7 weight % amino triazine type novolac curing agent (GUN EI Chemical Industry co., ltd, PS-6313, 148 g/eq) of 56.50 g (solvent: 2-methoxyethanol) were mixed with benzophenol as photo initiator forming radical by UV of 5 g, and the mixture was agitated with a rate of 300 rpm, at 90° C., for 1 hour. Subsequently, after adding a 70.93 g of spherical silica having a size distribution of 0.6 to 1.2 μm, the mixture was agitated with a rate of 400 rpm for 3 hours. After lowering the temperature of the mixture to room temperature, a 2-ethyl-4-methyl imidazole of 0.5 g was added and agitated for 30 minutes to provide an insulating material composition.

Each insulating material composition manufactured in Example 1 and Comparative Example was performed for film casting on a PET film, and cured by 193 nm of UV and completely cured by heat-treating at 90° C. for 30 minutes, and 200° C. for 120 minutes. Flame retardancy, Tg and CTE were measured by manufacturing dog-bone typed specimens. Measurement results were shown in the following table 1.

TABLE 1

| | flame retardant | | CTE (less than Tg) |
|---|---|---|---|
| | characteristic (UL 94V) | Tg (° C.) | (×10⁻⁶/K) |
| Example 1 | V-0 | 160.61 | 27.58 |
| Comparative | V-0 | 149 | 54.4 |
| example | | | |

Measuring Method of Physical Properties

1) flame retardancy measurement: according to UL 94 V (Vertical Burning Test) method, a sample was held perpendicularly and burned by a burner and the flame retardancy was rated as the V-2, V-1, V-0, 5V according to the extent of flaming combustion.

2) Tg and CTE measurement: Tg and CTE were measured by using the TMA Q 400 thermal analyzer of the TA Co, Ltd. Tg was adopted at the second scanning. Tg and CTE were measured at the temperature range of 25 to 250° C. with a heating speed of 10° C./min.

As shown in the table 1, it is noted that the flame retardant compositions of the Example 1 and Comparative Example have similar flame retardancy of V-0, that is, the burning time of a sample is 10 seconds or less.

In the Comparative Example, the photo initiator that forms radicals by UV was used and large amount of a reactive diluent of acrylate monomer must be included to express proper performance of the photo initiator. The result also has low Tg value and high CTE value since the reactive diluent included in the reaction has low Tg value and high CTE value compared with conventional epoxy resin. Therefore, comparing Tg values, while the composition of Comparative Example is difficult to use as a board material, one of example 1 has an excellent dimensional stability and also has an excellent CTE value compared with comparative example.

It is apparent that the present invention is not limited to the embodiments set forth above and many of applications may be made by those skilled in the art without departing from the principle and spirit of the present invention, the scope of which is defined in the appended claims and their equivalents.

What is claimed is:

1. A flame retardant resin composition for a printed circuit board, the flame retardant resin composition comprising:
(a) a complex epoxy resin comprising 1 to 40 parts by weight of a bisphenol A type epoxy resin with an average epoxy resin equivalent of 100 to 700, 1 to 60 parts by weight of a cresol novolac epoxy resin with an average epoxy resin equivalent of 100 to 600, 1 to 20 parts by weight of a rubber-modified epoxy resin with an average epoxy resin equivalent of 100 to 500, and 1 to 30 parts by weight of a phosphorus type epoxy resin with an average epoxy resin equivalent of 400 to 800;
(b) a photo acid generator mixed 0.1 to 10 parts by weight on the basis of 100 parts by weight of the complex epoxy resin;
(c) a curing agent mixed an equivalent ratio of 0.1 to 1.3 with respect to the total epoxy group equivalent of the complex epoxy resin;
(d) a curing accelerator mixed 0.1 to 1 parts by weight on the basis of 100 parts by weight of the complex epoxy resin; and
(e) an inorganic filler mixed 10 to 50 parts by weight on the basis of 100 parts by weight of the complex epoxy resin.

2. The flame retardant resin composition of claim 1, wherein the photo acid generator is a cationic photo initiator.

3. The flame retardant resin composition of claim 2, the cationic photo initiator is at least one selected from a group consisting of aryl diazonium salt, diaryliodonium salt, triaryl sulphonium salt, triaryl selenonium salt, dialkyl phenacyl sulphonium salt, triaryl sulphoxonium salt, aryloxydiaryl sulphoxonium salt and dialkylphenacyl sulphoxonium salt.

4. The flame retardant resin composition of claim 1, wherein the curing agent is at least one selected form a group consisting of phenol novolac, bisphenol novolac and a mixture thereof.

5. The flame retardant resin composition of claim 1, wherein the curing accelerator is an imidazole type compound.

6. The flame retardant resin composition of claim 1, wherein the curing accelerator is at least one selected from the group consisting of 2-ethyl-4-methylimidazole, 1-(2-cyanoethyl)-2-alkylimidazole, 2-phenyl imidazole and a mixture thereof.

7. The flame retardant resin composition of claim 1, wherein the inorganic filler is at least one inorganic material selected from the group consisting of barium titanium oxide, barium strontium titanate, titanium oxide, lead zirconium titanate, lead lanthanum zirconate titanate, lead magnesium niobate-lead tiatanate, silver, nickel, nickel-coated polymer sphere, gold-coated polymer sphere, tin solder, graphite, tantalum nitride, metal silicon nitride, carbon black, silica, clay and aluminum borate.

8. The flame retardant resin composition of claim 1, wherein the inorganic filler is surface-treated with a silane coupling agent.

9. A printed circuit board, wherein an insulating layer is formed by using the flame retardant resin composition of claim 1.

10. A method for manufacturing a printed circuit board comprising:
laminating an insulating layer formed from flame retardant resin composition of claim 1 to a substrate;
imprinting the substrate using an extruded patterned stamper and UV curing; and
releasing the stamper and thermal curing.

11. The method of claim 10, wherein the stamper has a polymer material.
